(19) United States
(12) Patent Application Publication
(10) Pub. No.: US 2025/0334052 A1
(43) Pub. Date: Oct. 30, 2025

(54) SUPPORT RIB FOR AIRFOIL

(71) Applicant: RTX CORPORATION, Farmington, CT (US)

(72) Inventor: Rutva A. PATEL, Middletown, CT (US)

(73) Assignee: RTX CORPORATION, Farmington, CT (US)

(21) Appl. No.: 18/644,803

(22) Filed: Apr. 24, 2024

(51) Int. Cl. F01D 5/14; F01D 9/04

(52) U.S. Cl. CPC F01D 5/147; F01D 9/041; F05D 2220/323; F05D 2230/23; F05D 2240/12; F05D 2240/30; F05D 2300/6033; F05D 2300/6034

(57) ABSTRACT

A support rib and an airfoil having a support rib where the support rib is formed from a central joined section which includes at least one ply of woven bidirectional fibers, a first end section, and a second end section where the first and second end sections are positioned on opposing ends of the central joined section. The first end section, and the second end section each have at least two plies of woven bidirectional fibers. The support rib joins two radial tubes to form an airfoil where the central joined section of the support rib joins the adjacent circumferential surfaces of the radial tubes and the first and second end sections join to the curved surfaces of the outer circumferential surfaces of the radial tubes, respectively.

### FIELD OF THE INVENTION

The present application relates to an airfoil support structure for joining two radial tubes of an airfoil together, an airfoil comprised of at least two radial tubes joined by an airfoil support structure and methods for producing a two dimensionally stabilized airfoil, including a woven support structure joining the radial tubes of the airfoil.

### BACKGROUND

Jet engines, in general, include a fan section, a compressor section, a combustion chamber, and a turbine section. The compressors and turbine sections include airfoils structures in the form of vanes (static structures) and blades (rotating structures). Airfoil structures have a pressure side, a suction side, a leading edge, and a trailing edge. As fluid flows over the airfoil from the leading edge towards the trailing side, a pressure differential is created leading to higher pressure at the pressure side and lower pressure at the suction side.

The pressure differential between the pressure and suction sides of the airfoil causes the airfoil to bulge, i.e., increasing the distance between the pressure and suction sides. This bulging phenomenon causes hoop stresses to develop including at the leading edge and the trailing edge, driving high stress formation in the hoop direction, i.e., around the outer circumference of the airfoil.

To reduce the occurrence of such bulging, one or more support ribs may be placed within the airfoil to bridge the pressure side and the suction side. By connecting the pressure and suction sides of the airfoil by the support rib(s), radial stress may be locally reduced. This alleviates stress and redirects it to the rib fillets, i.e., the location where the rib meets the airfoil profile.

Support ribs are generally formed using unidirectional fibers within a matrix to form a composite material. Such one unidirectional fiber composites have load carrying fibers running in only one direction, for example, in the thickness direction of the airfoil. The other directions being matrix dominated. Therefore, the resulting one-dimensional rib has both limited stiffness and limited thermal conduction capabilities in the hoop direction of the airfoil.

There is an existing need to improve existing support rib design to enhance stiffness and improve thermal conductivity in both the bulge and hoop directions.

### SUMMARY OF THE INVENTION

In some embodiments of the present disclosure, an airfoil support rib is provided where the airfoil support rib includes a central joined section, a first end section, and a second end section.

The central joined section includes at least one ply containing woven fibers in a ceramic matrix, the central joined section has a front surface and a back surface where the area between the front surface and the back surface defines the thickness of the support rib. The central joined section further includes a first end and a second end where the first and second ends are positioned opposite of each other.

The first end section includes at least two plies containing woven fibers in a ceramic matrix. Each of the at least two plies of the first end section extend from the central joined section at the first end of the central joined section. At least one ply of the first end section extends outwardly from the front surface of the central joined section in the thickness direction and at least one ply of the first end section extends outwardly from the back surface of the central joined section in the thickness direction;

The second end section includes at least two plies containing woven fibers in a ceramic matrix. Each of the at least two plies of the second end section extends from the central joined section at the second end of the central joined section. At least one ply of the first end section extends outwardly from the front surface of the central joined section in the thickness direction and at least one ply of the second end section extends outwardly from the back surface of the central joined section in the thickness direction.

In some embodiments of the present disclosure, an airfoil is provided having a first radial tube and a second radial tube. The first radial tube and a second radial tube have a length, a width, and a thickness, where the length and width of each of the first radial tube and the second radial tube form a top and bottom surface on each of the first radial tube and the second radial tube where the thickness of the first radial tube and a second radial tubes separated the top and bottom surfaces.

The first and second radial tubes have an outer circumferential surface whose length and width is defined by the thickness of the first and second radial tubes. A portion of the outer circumferential surface of the first and second radial tubes define complementary flat surfaces of the first and second radial tubes. The complementary flat surface of the first radial tube is positioned adjacent to the complementary flat surface of the second radial tube. The outer circumferential surface of the first and second radial tubes have at least two curved surfaces positioned above and below the complementary flat surfaces of the first and second radial tubes;

The airfoil also includes at least one support rib positioned between the first radial tube and a second radial tube and attached to both the complementary flat surfaces of the first radial tube and a second radial tube. The support rib includes a central joined section, a first end section, and a second end section.

The central joined section includes at least one ply containing woven fibers in a ceramic matrix, the central joined section has a front surface and a back surface where the area between the front surface and the back surface defines the thickness of the support rib. The central joined section further includes a first end and a second end where the first and second ends are positioned opposite of each other.

The first end section includes at least two plies containing woven fibers in a ceramic matrix. Each of the at least two plies of the first end section extend from the central joined section at the first end of the central joined section. At least one ply of the first end section extends outwardly from the front surface of the central joined section in the thickness direction and at least one ply of the first end section extends outwardly from the back surface of the central joined section in the thickness direction;

The second end section includes at least two plies containing woven fibers in a ceramic matrix. Each of the at least two plies of the second end section extends from the central joined section at the second end of the central joined section. At least one ply of the first end section extends outwardly from the front surface of the central joined section in the thickness direction and at least one ply of the second end section extends outwardly from the back surface of the central joined section in the thickness direction.

In some embodiments of the present disclosure, a method for making an airfoil is provided. The method includes joining a first radial tube to a second radial tube via a support rib.

The first radial tube and a second radial tube have a length, a width, and a thickness, where the length and width of each of the first radial tube and the second radial tube form a top and bottom surface on each of the first radial tube and the second radial tube where the thickness of the first radial tube and a second radial tubes separated the top and bottom surfaces.

The first and second radial tubes have an outer circumferential surface whose length and width is defined by the thickness of the first and second radial tubes. A portion of the outer circumferential surface of the first and second radial tubes define complementary flat surfaces of the first and second radial tubes. The complementary flat surface of the first radial tube is positioned adjacent to the complementary flat surface of the second radial tube. The outer circumferential surface of the first and second radial tubes have at least two curved surfaces positioned above and below the complementary flat surfaces of the first and second radial tubes;

The airfoil also includes at least one support rib positioned between the first radial tube and a second radial tube and attached to both the complementary flat surfaces of the first radial tube and a second radial tube. The support rib includes a central joined section, a first end section, and a second end section.

The central joined section includes at least one ply containing woven fibers in a ceramic matrix, the central joined section has a front surface and a back surface where the area between the front surface and the back surface defines the thickness of the support rib. The central joined section further includes a first end and a second end where the first and second ends are positioned opposite of each other.

The first end section includes at least two plies containing woven fibers in a ceramic matrix. Each of the at least two plies of the first end section extend from the central joined section at the first end of the central joined section. At least one ply of the first end section extends outwardly from the front surface of the central joined section in the thickness direction and at least one ply of the first end section extends outwardly from the back surface of the central joined section in the thickness direction;

The second end section includes at least two plies containing woven fibers in a ceramic matrix. Each of the at least two plies of the second end section extends from the central joined section at the second end of the central joined section. At least one ply of the first end section extends outwardly from the front surface of the central joined section in the thickness direction and at least one ply of the second end section extends outwardly from the back surface of the central joined section in the thickness direction.

In some embodiments of the disclosure, the central joined section includes a plurality of inner plies. The fibers of the piles of the airfoil support rib include warp fibers and weft fibers woven together at a perpendicular angle. The fibers of the piles of the airfoil support rib may be SiC fibers coated with boron nitride.

In some embodiments of the disclosure, the total surface area of the central joined section is substantially equal to the total area of the complementary flat surfaces of the first and second radial tubes. Some airfoils of the current disclosure include a plurality of support ribs. In some embodiments, each of the plurality of support ribs are spaced from each other.

### BRIEF DESCRIPTION OF THE DRAWINGS

Implementations of the inventive concepts disclosed herein may be better understood when consideration is given to the following detailed description thereof. These drawings are not necessarily to scale, and which some features may be exaggerated and some features may be omitted or may be represented schematically in the interest of clarity. Like reference numerals in the drawings may represent and refer to the same or similar element, feature, or function. In the drawings:

FIG. 1 illustrates an airfoil and the stresses imposed on the airfoil as a result of the pressure difference between the pressure side and the suction side of the airfoil.

FIG. 2 illustrates an airfoil with a support rib positioned between a pair of airfoil radial tubes in the radial direction.

FIG. 3 illustrates two tubes of an airfoil being joined by a support rib where the support rib is exaggerated as extending beyond the bounds of the airfoil tubes.

FIG. 4 illustrates a comparative non-woven fiber support rib.

FIG. 5 illustrates a cross section along line A-A in FIG. 4.

FIG. 6 illustrates a perspective view of an example weave pattern forming a support rib with warp and weft yarns at diagonals.

FIG. 7 illustrates an I shaped support rib.

FIG. 8 illustrates an I shaped support rib with a plurality of inner plies.

FIG. 9 illustrates an I shaped support rib positioned between a pair of airfoil tubes.

### DETAILED DESCRIPTION

Broadly, embodiments of the inventive concepts disclosed herein are directed to solutions to address the multidimensional stresses placed on an airfoil as a result of the pressure difference between the pressure side and the suction side.

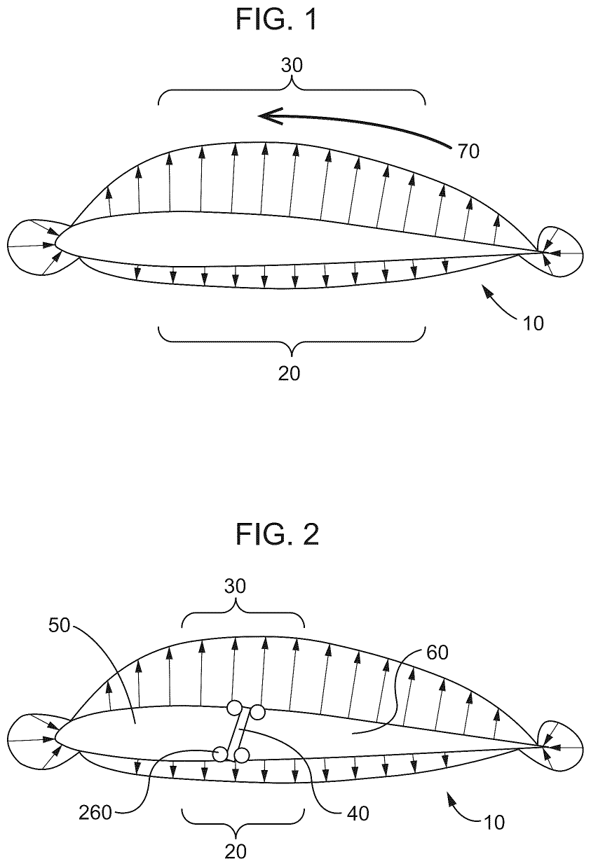

FIG. 1 shows the direction of forces applied to airfoil (10) caused by the pressure difference between the pressure side (20) and suction side (30). A bulging effect occurs caused by the pressure differential between the pressure side (20) and suction side (30) which results in outward bulge stress which also drives high hoop stresses (70) on the airfoil. These stresses include both load stress and thermal gradients which occur due to pressure loading and the environment in which the airfoil is operating.

One will understand that the airfoil (10) described herein may be a part of an aircraft where the airfoil (10) spans radially, relative to the central engine axis of an air craft (not shown). The terminology “first” and “second” as used herein is to differentiate that there are two architecturally distinct components or features. It is to be further understood that the terms “first” and “second” are interchangeable in the embodiments herein in that a first component or feature could alternatively be termed as the second component or feature, and vice versa.

FIG. 2 illustrates an airfoil (10) with a support rib positioned between a pair of radial tubes (50) and (60) in the radial direction. The support rib (40) is positioned between a first radial tube (50) and a second radial tube (60) which combine to form the airfoil (10). It will be understood, that the first radial tube (50) and the second radial tube (60) can be different shapes and sizes other than that shown in FIG. 1. The specific shape of the support rib (40) will also vary to conform to the relevant surfaces of the first radial tube (50) and the second radial tube (60) which the support rib (40) interfaces with. Once the support rib (40) is in position as shown in FIG. 2, the bulge stress is reduced but only limited degree. The support rib (40) is also subject to failure at the rib fillets (260). The stress reacts out at the location where the support rib (40) meets the airfoil profiles forming rib fillets (260).

As noted above, the pressure difference between the pressure side (20) and suction side (30) of the airfoil causes the airfoil to bulge as indicated by the arrows of the figure. The support rib (40) acts to counter this bulge stress but only because the support rib (40), as shown, is connected to the radial tubes (50) and (60) prevents their movement in the radial direction. Preventing the outward radial movement of (50) and (60) provides limited relief to bulge stress but does not directly counter stress in the hoop direction. Only by its interaction with the radial tubes (50) and (60) is any hoop direction stress alleviated and this effect is both weak and subject to failure at rib fillets (260).

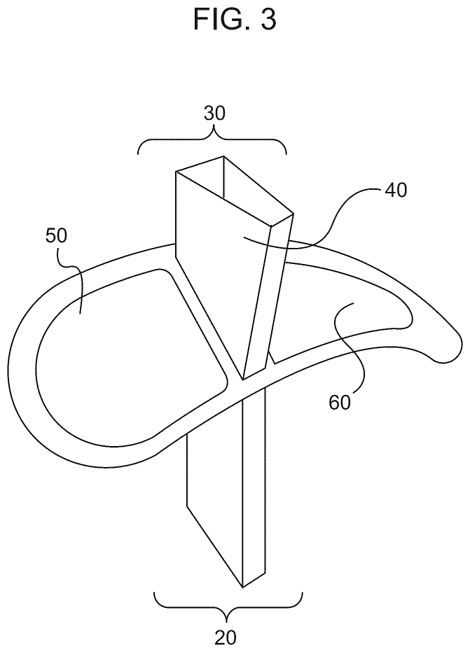

FIG. 3 shows radial tubes (50) and (60) of an airfoil (10) being joined by a support rib (40) where the support rib is exaggerated as extending beyond the bounds of the airfoil tubes. The support rib (40) is positioned in the radial direction of the airfoil (10) and is joined to the adjacent outer circumferential surfaces of both radial tubes (50) and (60). Support rib (40) can vary in cross sectional thickness as well as orientation angle to optimize functionality.

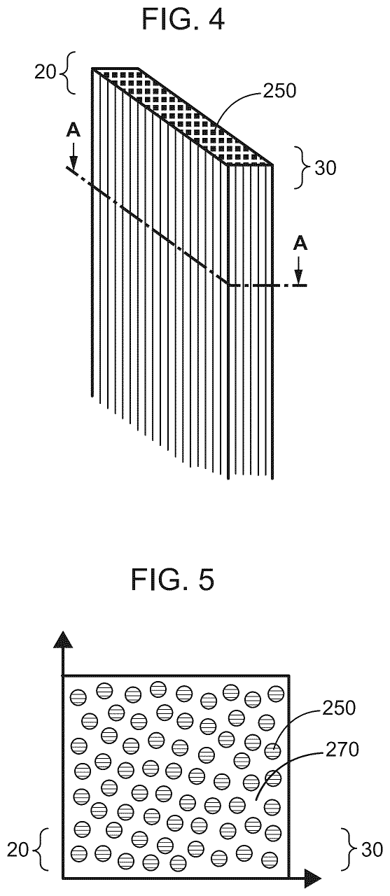

FIG. 4 shows a typical rib design (40) that uses non-woven, unidirectional fibers. Fibers (250) are unidirectionally aligned in the general direction which is perpendicular to the lengthwise direction of the airfoil (10) between the pressure side (20) and suction side (30). The fibers are encapsulated by a matrix material. Such a support rib provides little support to counter bulge stress in the hoop direction except that provided though its interaction with the radial tubes (50) and (60). Additionally, the unidirectionally aligned fibers (250) provide little thermal dispersal capacity to ameliorate thermal gradients between the pressure side (20) and the suction side (30).

FIG. 5 shows a cross sectional view taken along line A-A in FIG. 4 showing the randomly dispersed unidirectional fibers (250) within the matrix material (270) where the unidirectional fibers (250) run between the pressure side (20) and suction side (30) perpendicular to the bulge stress, i.e., the lengthwise direction of the airfoil. Due to the unidirectional alignment of the fibers, such a configuration has a limited ability to reduce stress and also has limited thermal conduction. A support rib (40) configured in this manner can also result in arbitrary fiber placement as their fibers are placed using hand-layup.

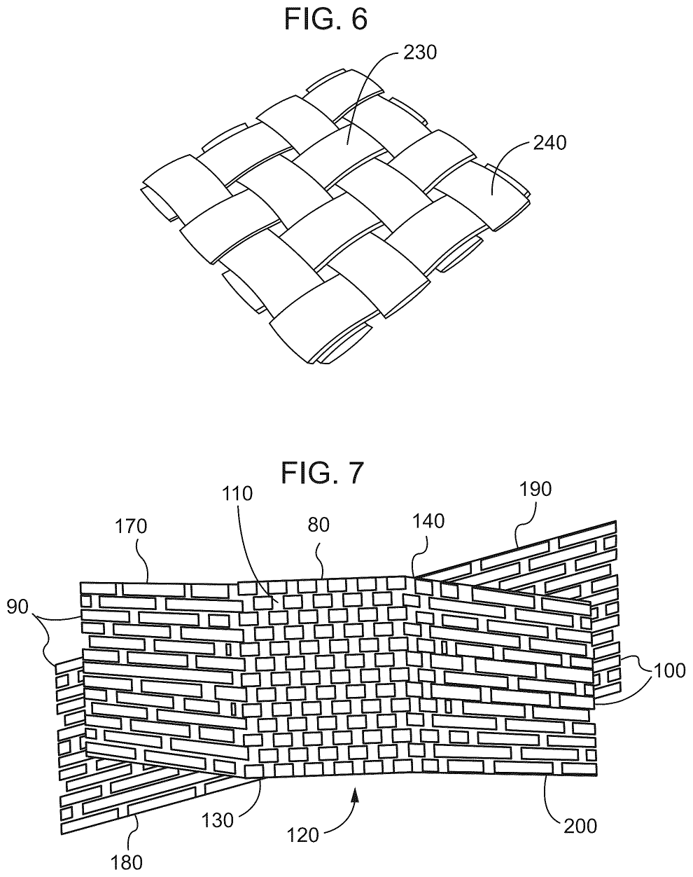

FIG. 6 shows a perspective view of an embodiment of a 2D woven fiber structure of a ply of a support rib (40) according to the present disclosure. As shown, the fibers are going in both the, x and y directions and are oriented generally perpendicular to each other. FIG. 6 shows the simplest of 2D weaves. Other variations are contemplated. If one put, for example, two of the “fabrics” of FIG. 6 on top of one another and stitched them together, the stiches that stitched them together would be in the z direction and a 3D weave would be formed.

As shown in FIG. 6, the warp fibers (230) are woven together with the weft fibers (240) at perpendicular angles. The bidirectional fibers (230) and (240) provide enhanced load carrying and thermal conductance capacity and assists the matrix support in carrying the relevant loads. Matrix support is provided at least for 2 adjacent plies to distribute load. With the support rib (40) provided herein, both fiber and matrix are directly carrying the load, including in the hoop direction. This is advantageous compared to 1D ribs where only the matrix carries any load in the hoop direction. For most composites, fibers are about 2-5 times stronger than the matrix.

The fibers may also have a coating applied to them.

Such an arrangement also provides a consistent cross section as the fibers are woven in a known and predictable manner. For example, such a structure may be woven on a loom to result in a consistent cross section. Such a consistent cross section provides consistent predictable load carrying and thermal conductance performance throughout the material.

The weave may be a ceramic matrix material (CMC). For example, the fibers may be SiC fibers coated with in-situ boron nitride to form a SiC fiber cloth with a chemical vapor infiltration (CVI), slurry cast, and melt infiltrated matrix.

Such woven fibers have enhanced load carrying and thermal conduction capabilities in comparison to unidirectional fibers. Thermal gradients can be a major stress driver in composite parts. Therefore, improving thermal conductance throughout the structure reduces thermal gradients and relative stresses. This capability is greatly enhanced through the use of the woven structure with warp fibers (230) and welp fibers (240) at perpendicular angles which can be aligned with the directions of the bulge and hoop stresses experienced by the airfoil.

FIG. 7 shows an example embodiment of a support rib (40) having an I shape in accordance with the present disclosure. The support rib (40) includes a central joined section (80) where the support rib (40) has been provided as a single woven structure. As illustrated this structure is a 2D weave. However, this central section (80) may exhibit a 3D weave configuration with the support rib (40) able to have independently varying thickness by adding additional plies. In addition to the central joined section (80), the support rib (40) also includes a first end section (90) and a second end section (100). The central joined section (80) includes a woven fiber structure having a length and a width and also having a front surface (110) and a back surface (120) opposite of the front surface which is not directly shown in the figure. The area between the front surface and the back surface defines the thickness of the rib structure and the thickness direction. This thickness can be adjusted by adding additional plies to the section. The first end sections (90) and second end sections (100) extend from the central joined section (80) in this thickness direction.

The each of the two first end sections (90) and the two second end sections (100) are woven fiber structures having a length and a width. Each of the first end sections (90) extend from the central joined section (80) at a first end (130) of the central joined section (80) and each of the second end sections (100) extend from the central joined section (80) at a second end (140) of the central joined section (80). This structural arrangement results in the ability to accommodate high interlaminar stresses.

As shown in FIG. 7, the first end section (90) includes a first outer ply (170) which extends outward from the front surface (110) of the central joined section (80) in the thickness direction. The first end section (90) also includes a second outer ply (180) which extends outward from the back surface (120) of the central joined section (80). It will be understood that any of the sections of the support rib (40) can vary in thickness independently by adding additional plies to the section.

Similarly, in the second end section (100) a first outer ply (200) extends outward from the front surface (110) of the central joined section (80) in the thickness direction. Also, in the second end section (100), the second outer ply (190) extends outward from the back surface (120) of the central joined section (80).

In the embodiment of FIG. 7, the outer plies have the same width and length. However, depending on the design of the rib support, the outer plies may vary in lengths and/or width and/or thickness.

Thus, the length, width and thickness of the outer plies may be independently varied so as to optimized the rib design for the particular needs of a given embodiment. For example, the outermost outer plies can have length greater than an outer ply positioned closer to the interior of the support rib. Also, the thickness of the outer plies can be varied by increasing/decreasing the size of the fibers (or bundles of fibers) used to form the relevant woven structures. That is, the thickness of the warp (230) and/or weft fibers structures (240) can have varying radial heights.

In some embodiments, all sections of the support rib (40) have the same thickness. This includes the central joined section (80) and outer plies (170-200). For example, the support rib (40) may be a 2D weave where all sections are equivalent in thickness to a single ply.

For simplicity, only two outer plies of the support rib (40) are shown. It should be recognized that the support rib can include a multiplicity of such outer plies. Also, as discussed further below, the support rib can include one or more inner plies to achieve a desired thickness of the support rib.

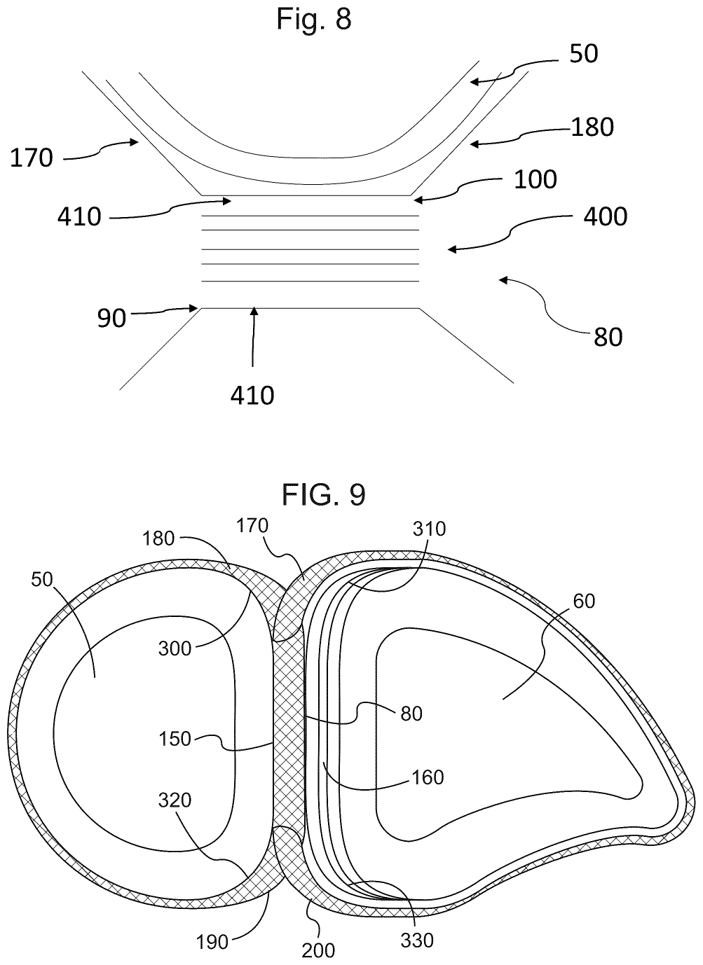

FIG. 8 shows a support rib (40) having a plurality of inner plies (400), positioned between the outer plies (410). Outer plies (410) differ from inner plies (400) in that the outer plies (410) interact with radial tubes (50) and (60) whereas the inner plies (400) are sandwiched between outer plies. In embodiments, with no inner plies (400), the outer ply (410) can be a single ply with the front and back surfaces (110) and (120) interfacing with the radial tubes (50) and (60).

The overall thickness of the support rib (40) can be varied by the inclusion of inner plies (400) which are positioned between the outer plies, in the central section (80) of the support rib (40). If the number of plies in, for example, the central joined section (80) increases, the thickness of the central joined section (80) will also increase. Such inner plies (400) need not have a first or a second end section corresponding to the first (90) and second (100) end sections of the outer plies, but instead only form part of the central section (80) of the support rib (40). For example, the central section (80) of the rib (40) can be made of several inner plies (400) and the central sections of the outer plies woven together with a 3D weave configuration. For example, the support rib (40) can contain 2 to 10 outer plies and 2 to 10 inner plies (400) wherein the inner plies (400) and the central section of the outer plies are joined together by a 3D weave configuration. The number of plies in any given embodiment may be bounded by the need for an effective densification processes e.g., CVI process to form CMC. At some point the addition of plies to a given section will negatively affect the densification process. Optimization of this aspect is contemplated in this disclosure.

In FIG. 8, one outer ply (410) as shown attached to radial tube (50). It will be understood that the out first outer ply (170) and second outer ply (180) continue all the way around the circumference of radial tube (50) as shown in FIG. 9 and that this is mirrored on the other side of the support rib (40) the radial tube (60) which is not shown.

FIG. 9 shows the embodiment of the support rib (40) shown in FIG. 7 positioned into an airfoil (10) between radial tubes (50) and (60). The radial tubes (50) and (60) are depicted as not fully attached but one will understand that the complementary flat surface (150) of the first radial tube (50) and the complementary flat surface (160) of the second radial tube (60) will fully join together via the central joined section (80) of the support rib (40) in a finished airfoil (10).

The central joined section (80) of the support rib (40) attaches on its front surface (110) to the complementary flat surface (150) of the first radial tube (50) and the central joined section (80) of the support rib (40) attaches on its back surface (120) to the complementary flat surface (160) of the second radial tube (60).

The two first end sections (90) of the support rib (40) are also visible in FIG. 9, i.e., first outer ply (170) and second outer ply (180). The second outer ply (180) is shown as being attached to the curved surface of the outer circumferential surface (300) of the first radial tube (50) which is positioned above the complementary flat surfaces (150) of the first radial tube (50). One will understand that when the airfoil (10) is complete, the first outer ply (170) will attached to the curved surface of the outer circumferential surface (310) of the second radial tube (60) which is positioned above the complementary flat surfaces (160) of the second radial tube (60).

The two plies of the second end section (100) of the support rib (40) are also visible in FIG. 9, i.e., first outer ply (200) of the second end section (100) and the second outer ply (190) of the second end section (100). The second end sections (190) and (200) will mirror the first end outer plies (170) and (180) in the manner in which it is attached to the radial tubes. Thus, first ply (190) and second ply (200) attach to the bottom curved surfaces (320) and 330), respectively, of the outer circumferential surfaces of the first (50) and second (60) radial tubes.

The central joined section (80) of the support rib (40) primarily acts to counter bulge stress caused by the pressure differential between the pressure side (20) and suction side (30). The first end sections (90) and the second end sections (100) of the support rib (40) each form parts of the rib fillets (260) and thus act to counter stress in the hoop direction. That is, the structure provides increased stiffness and thermal conductivity in the hoop and bulge directions. This effect is further amplified by the specific woven structure of the support rib (40) as shown in FIG. 6.

As shown in FIG. 9, the central joined section (80) spans the full distance of the complementary flat surfaces (150) and (160), respectively, of the first radial tube (50) and second radial tube (60). In other words, the length and width of the central joined section (80) matches the length and width of the complementary flat surfaces (150) and (160) of the first radial tube (50) and second radial tube (60). In other embodiments, multiple support ribs (40) having a central joined section (80) with a lesser width may be used to join the first radial tube (50) and second radial tube (60) in a similar manner. In such embodiments, there is a gap between support ribs (40). In other embodiments, the support ribs (40) have central joined section (80) which has a lesser length may be used to join the first radial tube (50) and second radial tube (60) in a similar manner. In such embodiments, the lengths of the first end sections (90) and the second end sections (100) may be increased to join together a portion of the complementary flat surfaces (150) and (160) of the first radial tube (50) and second radial tube (60).

The fibers within the central section (80) may be aligned both parallel and perpendicular to the direction of the bulge stresses experienced by the airfoil (10) from the pressure difference between the pressure side (20) and suction side (30). The fibers within the first end sections (90) and second end sections (100) are aligned both parallel and perpendicular to the circumferential direction of the airfoil (10) and directly counter stresses in the hoop direction experienced by the airfoil (10) by providing a continuous support structure around the circumference of the first radial tube (50) and second radial tube (60). The alignment of the fibers and the overall structure created by the central section (80), first end sections (90), and second end sections (100) portions of the support rib (40) combine to counter the combination of stresses experienced by the airfoil (10) including those in the hoop direction.

Although not depicted, it will be appreciated by one skilled in the art, that the outer plies of the support rib (40) will not generally be the outermost surface of an airfoil (10). Instead, the airfoil will generally include additional plies or layers which traverse continuously the entire outer circumferential surface of the radial tubes (50) and (60) and support rib (40). The radial tubes (50) and (60) and support rib (40) generally make up the core section of the airfoil (10).

As will be appreciated by one skilled in the art, the embodiments described herein may be embodied as a method, product, or part of an airfoil (10) for use in, for example, an aircraft. Accordingly, the embodiments described herein may take the form a bidirectionally supported airfoil of an aircraft.

The corresponding structures, material, acts, and equivalents of all means or steps plus function elements in the claims below are intended to include any structure, material or act for performing the function in combination with other claimed elements are specifically claimed. The description of the embodiments described herein has been presented for purposes of illustration and description, but is not intended to be exhaustive or limited to the invention in the form disclosed. Many modifications and variations will be apparent to those of ordinary skill without departing from the scope and spirit of the invention. The embodiments were chosen and described in order to best explain the principles of the invention and the practical application, and to enable others of ordinary skill in the art to understand the invention for embodiments with various modifications as are suited to the particular use contemplated.

Modifications and equivalents may be made to the features of the claims without departing from the spirit or scope of the invention. Thus, it is intended that the embodiments described herein covers the modifications and variations disclosed above provided that these changes come within the scope of the claims and their equivalents.

1. An airfoil support rib comprising:
a central joined section comprising at least one ply containing woven fibers in a ceramic matrix, the central joined section having a front surface and a back surface wherein the area between the front surface and the back surface define a thickness of the support rib, the central joined section further comprising a first end and a second end wherein the first and second ends are positioned opposite of each other,
a first end section comprising at least two plies containing woven fibers in a ceramic matrix, wherein each of the at least two plies of the first end section extends from the central joined section at the first end of the central joined section and at least one ply of the first end section extends outwardly from the front surface of the central joined section in a thickness direction and at least one ply of the first end section extends outwardly from the back surface of the central joined section in the thickness direction;
a second end section comprising at least two plies containing woven fibers in a ceramic matrix, wherein each of the at least two plies of the second end section extends from the central joined section at the second end of the central joined section and at least one ply of the first end section extends outwardly from the front surface of the central joined section in the thickness direction and at least one ply of the second end section extends outwardly from the back surface of the central joined section in the thickness direction.

2. The airfoil support rib of claim 1 wherein the central joined section comprises a plurality of inner plies.

3. The airfoil support rib of claim 1 wherein the fibers of the piles of the airfoil support rib comprises warp fibers and weft fibers woven together at a perpendicular angle.

4. The airfoil support rib of claim 1 wherein the fibers of the piles of the airfoil support rib are SiC fibers coated with boron nitride.

5. An airfoil comprising:
a first radial tube and a second radial tube wherein the first radial tube and a second radial tube have a length, a width, and a thickness, wherein the length and width of each of the first radial tube and the second radial tube form a top and bottom surface on each of the first radial tube and the second radial tube where the thickness of the first radial tube and a second radial tubes separated the top and bottom surfaces,
wherein the first and second radial tubes have an outer circumferential surface whose length and width is defined by the thickness of the first and second radial tubes,
wherein a portion of the outer circumferential surface of the first and second radial tubes define complementary flat surfaces of the first and second radial tubes,
wherein the complementary flat surface of the first radial tube is positioned adjacent to the complementary flat surface of the second radial tube, and
wherein the outer circumferential surface of the first and second radial tubes have at least two curved surfaces positioned above and below the complementary flat surfaces of the first and second radial tubes; and
at least one support rib positioned between the first radial tube and a second radial tube and attached to both the complementary flat surfaces of the first radial tube and a second radial tube, the support rib comprising:
a central joined section comprising at least one ply containing woven fibers in a ceramic matrix, the central joined section having a front surface and a back surface wherein the area between the front surface and the back surface define a thickness of the support rib, the central joined section further comprising a first end and a second end wherein the first and second ends are positioned opposite of each other,
a first end section comprising at least two plies containing woven fibers in a ceramic matrix, wherein each of the at least two plies of the first end section extends from the central joined section at the first end of the central joined section and at least one ply of the first end section extends outwardly from the front surface of the central joined section in a thickness direction and at least one ply of the first end section extends outwardly from the back surface of the central joined section in the thickness direction;
a second end section comprising at least two plies containing woven fibers in a ceramic matrix, wherein each of the at least two plies of the second end section extends from the central joined section at the second end of the central joined section and at least one ply of the first end section extends outwardly from the front surface of the central joined section in the thickness direction and at least one ply of the second end section extends outwardly from the back surface of the central joined section in the thickness direction.

6. The airfoil of claim 5 wherein at least one ply of the first end section attaches to the curved surface of the outer circumferential surface of the first radial tube which is positioned above the complementary flat surface of the first radial tube and at least one ply of the first end section attaches to the curved surface of the outer circumferential surface of the of the second radial tube which is positioned above the complementary flat surface of the second radial tube.

7. The airfoil of claim 5 wherein at least one ply of the second end section attaches to the curved surface of the outer circumferential surface of the first radial tube which is positioned below the complementary flat surface of the first radial tube and at least one ply of the second end section attaches to the curved surface of the outer circumferential surface of the of the second radial tube which is positioned below the complementary flat surface of the second radial tube.

8. The airfoil of claim 5 wherein the fibers of the piles of the airfoil support rib comprises warp fibers and weft fibers woven together at a perpendicular angle.

9. The airfoil of claim 8 wherein warp fibers and weft fibers of the central joined section are generally oriented in the width and thickness directions of the radial tubes, and
wherein warp fibers and weft fibers of the second and second end sections are generally oriented in the thickness and length directions of the radial tubes.

10. The airfoil of claim 8 wherein the fibers of the woven fiber structures are SiC fibers coated with boron nitride.

11. The airfoil of claim 5 wherein the central joined section comprises a plurality of inner plies.

12. The airfoil of claim 5 wherein a total surface area of the central joined section is substantially equal to the total area of the complementary flat surfaces of the first and second radial tubes.

13. The airfoil of claim 5 comprising a plurality of support ribs.

14. The airfoil of claim 13 wherein each of the plurality of support ribs are spaced from each other.

15. A method for making an airfoil comprising:
joining a first radial tube to a second radial tube via a support rib;
wherein the first radial tube and a second radial tube have a length, a width, and a thickness, wherein the length and width of each of the first radial tube and the second radial tube form a top and bottom surface on each of the first radial tube and the second radial tube where the thickness of the first radial tube and a second radial tubes separated the top and bottom surfaces,
wherein the first and second radial tubes have an outer circumferential surface whose length and width is defined by the thickness of the first and second radial tubes,
wherein a portion of the outer circumferential surface of the first and second radial tubes define complementary flat surfaces of the first and second radial tubes,
wherein the complementary flat surface of the first radial tube is positioned adjacent to the complementary flat surface of the second radial tube, and
wherein the outer circumferential surface of the first and second radial tubes have at least two curved surfaces positioned above and below the complementary flat surfaces of the first and second radial tubes; and
at least one support rib positioned between the first radial tube and a second radial tube and attached to both the complementary flat surfaces of the first radial tube and a second radial tube, the support rib comprising:
a central joined section comprising at least one ply containing woven fibers in a ceramic matrix, the central joined section having a front surface and a back surface wherein the area between the front surface and the back surface define a thickness of the support rib, the central joined section further comprising a first end and a second end wherein the first and second ends are positioned opposite of each other,
a first end section comprising at least two plies containing woven fibers in a ceramic matrix, wherein each of the at least two plies of the first end section extends from the central joined section at the first end of the central joined section and at least one ply of the first end section extends outwardly from the front surface of the central joined section in a thickness direction and at least one ply of the first end section extends outwardly from the back surface of the central joined section in the thickness direction;
a second end section comprising at least two plies containing woven fibers in a ceramic matrix, wherein each of the at least two plies of the second end section extends from the central joined section at the second end of the central joined section and at least one ply of the first end section extends outwardly from the front surface of the central joined section in the thickness direction and at least one ply of the second end section extends outwardly from the back surface of the central joined section in the thickness direction.

16. The airfoil of claim 15 wherein at least one ply of the first end section attaches to the curved surface of the outer circumferential surface of the first radial tube which is positioned above the complementary flat surface of the first radial tube and at least one ply of the first end section attaches to the curved surface of the outer circumferential surface of the of the second radial tube which is positioned above the complementary flat surface of the second radial tube.

17. The airfoil of claim 15 wherein at least one ply of the second end section attaches to the curved surface of the outer circumferential surface of the first radial tube which is positioned below the complementary flat surface of the first radial tube and at least one ply of the second end section attaches to the curved surface of the outer circumferential surface of the of the second radial tube which is positioned below the complementary flat surface of the second radial tube.

18. The airfoil of claim 15 wherein the fibers of the piles of the airfoil support rib comprises warp fibers and weft fibers woven together at a perpendicular angle.

19. The airfoil of claim 18 wherein warp fibers and weft fibers of the central joined section are generally oriented in the width and thickness directions of the radial tubes, and wherein warp fibers and weft fibers of the second and second end sections are generally oriented in the thickness and length directions of the radial tubes.

20. The airfoil of claim 18 wherein the central joined section comprises a plurality of inner plies, and
wherein a total surface area of the central joined section is substantially equal to the total area of the complementary flat surfaces of the first and second radial tubes.
